(19) United States
(12) Patent Application Publication
(10) Pub. No.: US 2006/0085407 A1
(43) Pub. Date: Apr. 20, 2006

(54) Medical image display apparatus

(75) Inventors: Shigeo Kaminaga, Otawara-Shi (JP); Yuuji Hamada, Otawara-Shi (JP); Kazuhiro Katada, Aichi-Gun (JP)

Correspondence Address: OBLON, SPIVAK, MCCLELLAND, MAIER & NEUSTADT, P.C., 1940 DUKE STREET, ALEXANDRIA, VA, 22314, US

(73) Assignees: Kabushiki Kaisha Toshiba, Minato-Ku (JP); TOSHIBA MEDICAL SYSTEMS CORPORATION, Otawara-Shi (JP)

(21) Appl. No.: 11/249,520

(22) Filed: Oct. 14, 2005

(30) Foreign Application Priority Data
Oct. 15, 2004 (JP) 2004-302079

(51) Int. Cl. G06F 17/30

(52) U.S. Cl. 707/3

(57) ABSTRACT

A medical image display apparatus includes a device for storing image data for each study, acquired from a subject by a medical modality, and additional information thereof; a device for displaying list information about the study on a monitor based on the additional information; a device for selecting a study from the list information displayed on the monitor, in accordance with designated information; and a device for presenting volume data corresponding to the selected study and included in the image data, as information for collectively showing the presence of the volume data, i.e., as one-line list or thumbnails of a representative slice. With these features, it is possible to show that the designated study is accompanied with the acquired volume data, on a monitor screen in a simple and accurate manner, without the need to display information about all slices constituting the volume data.

### BACKGROUND OF THE INVENTION

1. Field of the Invention

The present invention relates to a medical image display apparatus for displaying image data acquired and stored by a medical modality such as an X-ray CT scanner or the like. More specifically, the present invention concerns a medical image display apparatus using an improved method for displaying volume data.

2. Description of the Related Art

In recent years, the technology of medical modalities such as X-ray CT apparatuses has made remarkable progress. In a conventional X-ray CT apparatus, one or more desired slices of a subject have been designated, and these slices have been subjected to X-ray scans, whereby tomograms such as axial images, coronal images, saggital images, or the like have been obtained from projection data acquired by the X-ray scans. These tomograms have served a diagnostic purpose in their own way, but because the thickness of slices used has been comparatively large, the above-described tomograms have been pointed out as leaving something to be desired in terms of the attainment of high-definition of images.

Under this situation, with the reduction of the detection pitch in an X-ray detector and the development of image reconstruction technique, combined with the recent progress of the technology of medical modalities, it has become possible to speedily scan slices with a minute thickness (width) of e.g., 0.5 mm at minute pitches, as disclosed in, e.g., Japanese Unexamined Patent Application Publication No. 2004-181069. As a result, so-called “volume data” (three-dimensional data) formed by stacking a large number of such thin, and small-pitched slices has become capable of being achieved in a short time. This allows a wide range of volume data on, e.g., an abdominal region, chest region, and the like to be easily obtained. Hence, by applying multi planar reconstruction (MPR) method to the volume data, images of an arbitrary cross section can be easily obtained. This has brought a greater value to the volume data than heretofore.

However, when attempting to acquire a cross-section converted image from volume data, or when attempting to read the cross-section converted image, the volume data display method to be executed has had a drawback to be solved.

Specifically, when a study of which the volume data has been acquired is designated on a display screen of a study list, the volume data, that is, a plurality of slices, are all displayed by lists or thumbnails. For example, supposing a study of a patient is accompanied with volume data comprising 1000 slices, lists displaying additional information corresponding to 1000 slices or thumbnails corresponding to the 1000 slices will simultaneously occupy a monitor screen for display.

Each slice of this volume data includes image information in its own way, but since the slice pitch is small as described above, the variations in pieces of image information between mutually adjacent slices is small. Hence, there is not so much necessity for us to observe all slices. By contrast, however, we frequently have difficulties treating the lists and thumbnails of all slices simultaneously displayed on the monitor screen. Nevertheless, for display processing and image-reading to be performed subsequently, it is very important to provide information, on the monitor, that volume data has been acquired in the designated study.

### SUMMARY OF THE INVENTION

The present invention is directed to overcoming the problems associated with the above-described conventional display method for volume data. Specifically, the present invention is directed to facilitating the treatment of the volume data by showing that the designated study is accompanied with acquired volume data, on the monitor screen in a simple and accurate manner, without the need to display information about all slices constituting the volume data.

To achieve the above-described object, the present invention provides a medical image display apparatus that includes an image data storage device for storing image data for each study, acquired from a subject by a medical modality, and additional information thereof; a list information display device for displaying list information about the study on a monitor based on the additional information; a study selection device for selecting an arbitrary study from the list information displayed on the monitor, in accordance with designated information; and a volume data presentation device for presenting volume data corresponding to the selected study and included in the image data, as information for collectively showing the presence of the volume data.

According to the present invention, volume data acquired in a study is displayed as information for collectively showing the presence of the volume data, e.g., as a list with one line or thumbnails of representative slices. By virtue of the display of the collectively shown information without displaying information about all slices constituting the volume data, it is possible to show that the designated study is accompanied with volume data, on a monitor screen in a simple and accurate manner, thereby allowing the facilitation of treating of the volume data.

### BRIEF DESCRIPTION OF THE DRAWINGS

FIG. 1 is a schematic block diagram showing the construction of a multi-slice CT apparatus (X-ray CT apparatus), as a medical modality, into which a medical image display apparatus according to the present invention is integrated;

FIG. 2 is a table listing additional information on image data for image display according to the present invention, the table being stored in an image database installed in the console of the multi-slice CT apparatus;

FIG. 3 is a flowchart showing the outline of the processes of image selection and image display that are to be executed by the CPU of the console;

FIG. 4 is a representation of a monitor screen on which a study list as list information about studies is displayed;

FIG. 5 is a representation of a monitor screen on which series information positioned at a lower hierarchical level than the study is displayed;

FIG. 6 is a representation of a monitor screen on which one-line lists are displayed;

FIG. 7 is a representation of a monitor screen on which volume thumbnails are displayed;

FIG. 8 is a representation of a monitor screen on which volume thumbnails and their cross-section conversion images are displayed;

FIG. 9 is a representation of a monitor screen on which volume thumbnails and thumbnails of cross-sectional conversion images of the volume thumbnails are displayed; and

FIG. 10 is a representation of a monitor screen on which another example of volume thumbnails are displayed.

### DESCRIPTION OF THE PREFERRED EMBODIMENTS

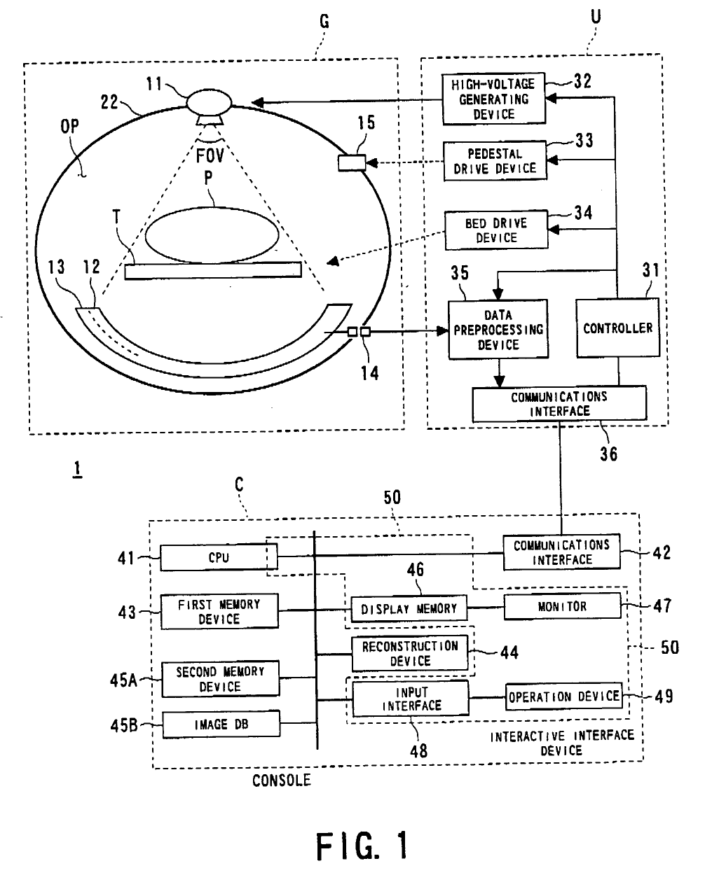

Hereinafter, an embodiment of the present invention will be described with reference to the accompanying drawings FIGS. 1 to 10.

FIG. 1 shows the construction of an X-ray CT apparatus into which a medical image display apparatus according to the present invention has been incorporated. This X-ray CT apparatus is constructed as a multi-slice CT apparatus 1. The medical image display apparatus according to the present invention is operated by a console of the multi-slice CT apparatus 1. Therefore, the explanation of the construction and effects of the medical image display apparatus according to the present invention will be incorporated into the description of this multi-slice CT apparatus 1.

This multi-slice CT apparatus 1 performs not only multi-slice helical scans but also conventional scans (single-slice scans and multi-slice scans), and can acquire/store image data on subjects.

Specifically, the multi-slice CT apparatus 1 includes a bed (not shown; its top board T is shown in FIG. 1) for placing thereon a subject (for example, a patient) P; a pedestal G having an opening OP for diagnosis into which the subject is inserted for diagnosis and performing the acquisition of projection data on the subjects P; a control/acquisition device U for controlling operations of the entire pedestal G and acquiring projection data; and the console C for performing image reconstruction processing, image display, and the like based on the acquired projection data.

The bed has the top board T capable of being slid along the longitudinal direction of the bed by the drive of a bed drive section (not shown). Usually, the subject P is placed on the bed so that the body axis thereof is conformed to the longitudinal direction of the bed.

The pedestal G has an X-ray tube 11 and an X-ray detector 12 oppositely disposed with the subject P inserted in the opening OP for diagnosis therebetween. Besides, the pedestal G includes a data acquisition system (DAS) 13, noncontact data transmission device 14, pedestal drive section 15, and so on.

The control/acquisition device U includes a controller 31, high-voltage generating device 32 driven by the control of the controller 31, pedestal drive device 33, bed drive device 34, and data preprocessing device 35. The data preprocessing device 35 and controller 31 are capable of interactive communications with the console C through a communications interface 36.

The X-ray tube 11, X-ray detector 12, and DAS 13 are arranged in a rotatable rotating ring 22 in the pedestal G. The X-ray detector 12 and DAS 13 are structurally integrated with each other. The rotating ring 22 rotates under the drive control by the pedestal drive section 15, and thereby the X-ray tube 11 and X-ray detector 12 (DAS 13) can be integrally rotated around the rotation center axis parallel to the body axial direction of the subject P inserted in the opening OP for diagnosis of the pedestal G. The rotating ring 22 is rotationally driven at a high rotational speed of one revolution or more per second.

Out of the arrangements on the pedestal side, the X-ray tube 11 emits X rays with cone-beam shape (quadrangular pyramid shape) or fan-beam shape, to the subject P placed in an effective FOV (field of view). Electric power (tube voltage and tube current) necessary for the radiation of X-rays is supplied to the X-ray tube 11 from the high-voltage generating device 32 via a slip ring (not shown). Thereby, the X-ray tube 11 generates so-called cone beam X-rays or fan beam X-rays extending in two directions: a slice direction parallel to the rotation center axis and a channel direction perpendicular to this slice direction. In a typical diagnosis, since the subject P gets on the top board T along the longitudinal direction of the bed, the slice direction conforms to the body axis direction of the subject P.

Also, between the X-ray tube 11 and subject P in the pedestal G, there is provided a collimator (not shown) for wave-shaping the cone-shaped or fan shaped X-ray beams, and forming a required size of X-ray beams.

The X-ray detector 12 is a device for detecting X-rays that have transmitted the subject P, and is formed by arranging, in an array configuration, a plurality of X-ray detection elements with a small element width in two directions orthogonal to each other (a slicing direction and channel direction), thereby providing a two-dimensional X-ray detector. In this embodiment, the X-ray detector 12 comprises a plurality of detector modules, which is arranged in the channel direction.

Two-dimensional X-ray transmission data acquired by the X-ray detector 12, that is, two-dimensional projection data, is converted into a digital amount by the DAS 13, and transmitted to the data preprocessing device 35 through the noncontact data transmission device 14. In this data preprocessing device 35, required correction processes such as a sensitivity correction, X-ray intensity correction are applied to the two-dimensional projection data. The two-dimensional projection data having been subjected to the preprocessing is sent to the console C through the communications interface 36.

The detecting operation by the X-ray detector 12 is repeated, for example, about 1000 times in one revolution (about 1 second). As a result, an enormous amount of two-dimensional projection data corresponding to M×N channels occurs 1000 times per 1 second (one revolution). In order to transmit, without delay, this enormous amount of two-dimensional projection data, which occurs in at a high speed, the operations of the DAS 13 and noncontact data transmission device 14 are performed at an ultrahigh speed.

As shown in FIG. 1, the console C includes a CPU 41, and various units operating under the control of the CPU 41. These units are, besides communications interface 42 having the function of performing interactive communications with the control/acquisition device U, a first memory device 43, reconstruction device 44, second memory device (HDD) 45A for storing reconstruction image data, image database (DB) 458, display memory 46, and input interface 48 for use in operation devices. A monitor 47 is connected to the display memory 46. An operation device 49 for mouse, keyboard and the like is connected to the input interface 48.

The projection data by each revolution, transmitted from the data preprocessing device 35 in the above-described control/acquisition device U through the communications interface 36 and 42, that is, the projection data by each 360 degree is once stored in the first memory device 43. The reconstruction device 44, in appropriate timing, applies reconstruction processing based on a fan-beam reconstruction mode or cone-beam reconstruction mode to the projection data stored in the first memory device 43, and thereby generates (reconstructs) tomogram data on each slice. For the reconstruction processing based on the cone-beam reconstruction mode, a reconstruction algorism referred to as the “Feldkamp method” is chiefly used. Thereby, tomogram data corresponding to a plurality of reconstructed slices, i.e., volume data, or ordinary slice tomogram data that is not volume data, is stored in the second memory device 45A.

Here, the term “volume data” refers to a group of slice images generated from projection data obtained by one time of study or scan, and is defined as a group of a plurality of slices acquired at a slice pitch (slice distance: the distance between the center points of slices) that are equal to or not more than a slice thickness. Usually, the scanning is frequently performed so that mutually adjacent slices are superimposed on one another, and in such cases, the actual voxel data becomes three-dimensional data without a gap between slices.

Under an instruction from an operator, the X-ray CT imaging is performed with respect to each subject (patient) using the multi-slice CT apparatus 1, and obtained volume data or ordinary slice data on each subject is stored in the second memory device 45A.

In the console C, a partial function of the CPU 41, the display memory 46, monitor 47, input interface 48, and operation device 49 functionally constitutes an interactive interface device 50 between the apparatus side and the operator. Hence, when attempting to perform scanning, the operator (image-reading doctor or the like) can make an imaging plan by inputting patient information (the patient ID, study ID, series ID, etc.), imaging plan information (slice width, slice distance (pitch), comment information, etc.) and the like, through the use of the above-described interface device 50, and thereby can perform the imaging operation. Here, this imaging plan information further includes information such as the scan starting position, scan ending position, filter to be used and its function, study region, body position, and presence/absence of contrast enhancement, and the like. Also, through the utilization of the interface device 50, the operator can generate slice images in a desired region of interest by the MPR, using the volume data stored in the second memory device 45A. The main reason therefore is because purposes of studies or diagnosis vary from one subject to another. The input information at the time of making the imaging plan or image data obtained by post-processing are stored in the image database 45B.

As a consequence, stored in the image database 45B are, image data for image display and image processing including the volume display according to the present invention, and additional information of the above-described image data, for each patient and for each study.

The image data includes volume data, and cross-sectional image data (axial images, coronal images, saggital images, and oblique images) acquired by the multi-slice CT apparatus 1 as a medical modality. Furthermore, the image database 45B stores a thumbnail of at least one representative slice out of a plurality of slices constituting volume data, the thumbnail having been prepared in advance to perform the image display according to the present invention (in this application, the thumbnail of this at least one representative slice is defined as a “volume thumbnail”); and stores thumbnails of the cross-sectional image data. The volume thumbnails are, for example, image data obtained by rendering, as thumbnails, slice image data located at the top, tail end, and the mid-point of a group of image data comprising a plurality of slices.

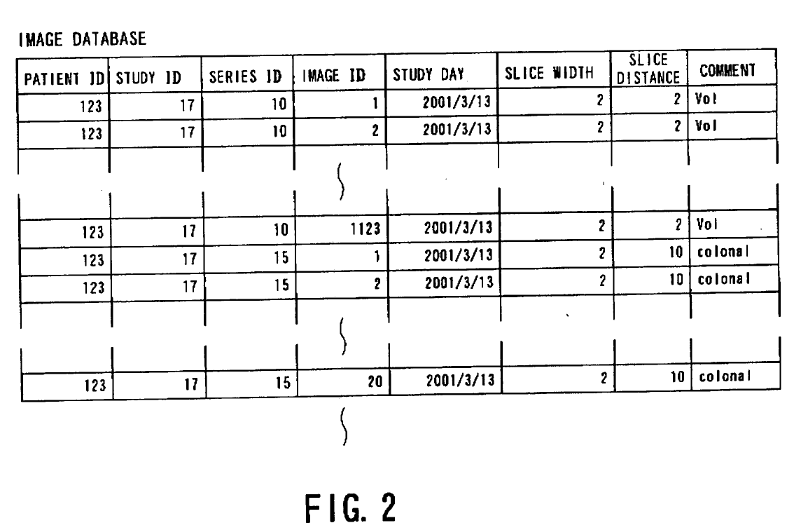

On the other hand, as shown in FIG. 2, the additional information is stored in the form of a table. The table of additional information shown in FIG. 2, which provides an example thereof, includes information about the patient ID, study ID, series ID, image ID, study day, slice width, slice distance, and comment. As described above, this table may include other information, such as the scan starting positions scan ending positions, filter to be used and its function, study region, body position, and presence/absence of contrast enhancement, and the like.

The table in FIG. 2 shows that, on the same study day, two series (series IDs are “10” and “15”) of imaging were performed with respect to the same patient and the same study (i.e., the patient IDs are the same, and the study IDs are the same) to obtain image data. Here, the term “series” refers to a group of image files obtained by imaging the same patient under certain identical conditions (e.g., the presence or absence of contrast enhancement; and filters used at the time of reconstruction are the same; or the like). Even if the same study of the same patient is provided, conditions for acquiring/generating image data are different at different “series”. The table in FIG. 2 shows that, as one series (series ID=“10”), there is volume data comprising 1123 pieces of image files of image IDs “1” to “1123”, which have been acquired under the conditions: the slice width=2 mm and the slice distance=2 mm. This table further shows that, as the other series (series ID “15”), there is coronal image data comprising 20 pieces of image files of image IDs “1” to “20”, which have been acquired under the conditions: the slice width=2 mm and the slice distance=10 mm.

That is, the table shown in FIG. 2 is prepared so as to form a three-level hierarchy comprising “study (patient)”, “series”, and “image file”.

This hierarchy is conformable to the standard regarding digital images and communications for medical application, the standard being referred to as “DICOM” (digital imaging and communication in medicine). In a part of this embodiment, the hierarchical levels of “series” and “image file” are integrated into one, and thereby the display processing is performed based on a two-level hierarchy comprising “study” (patient), and “series”+“image file”.

In this manner, the image database 45B in this embodiment constitutes an image data storage device and cross-section converted image storage device according to the present invention. Also, under the control of the CPU 41, the console C functionally constitutes a list information display device, study selection device, and the like.

Next, a description will be made of the display processing of volume data according to the present invention, to be performed in this embodiment.

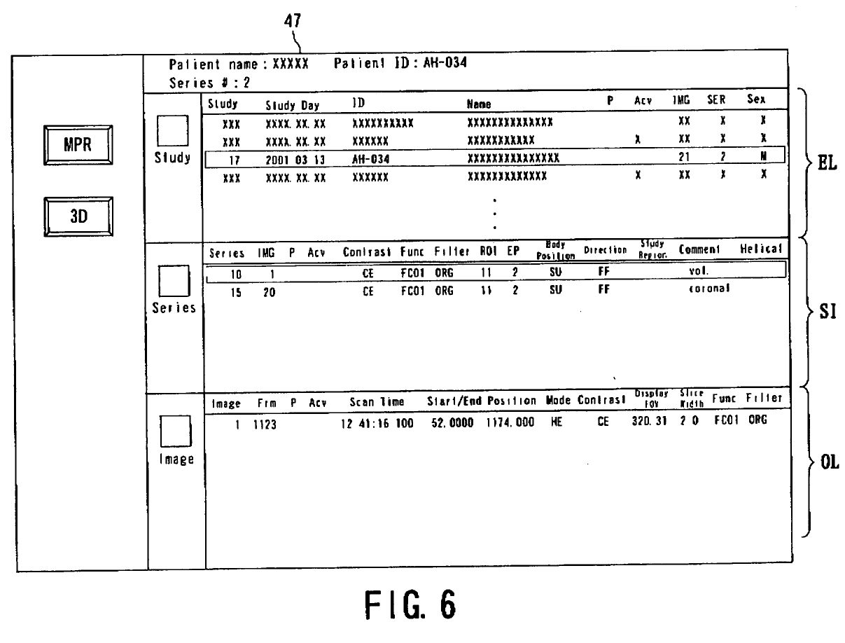

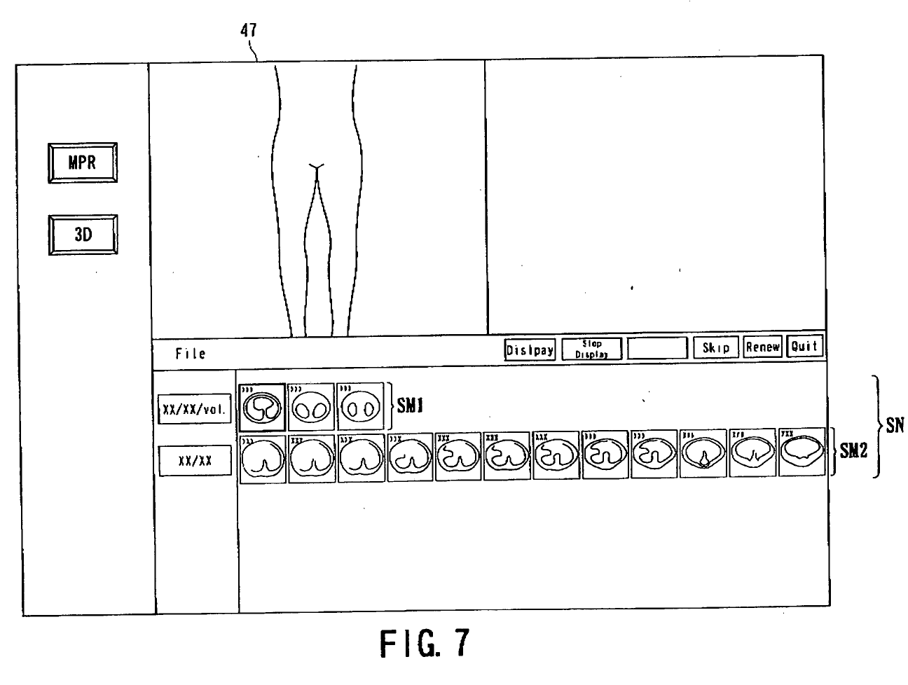

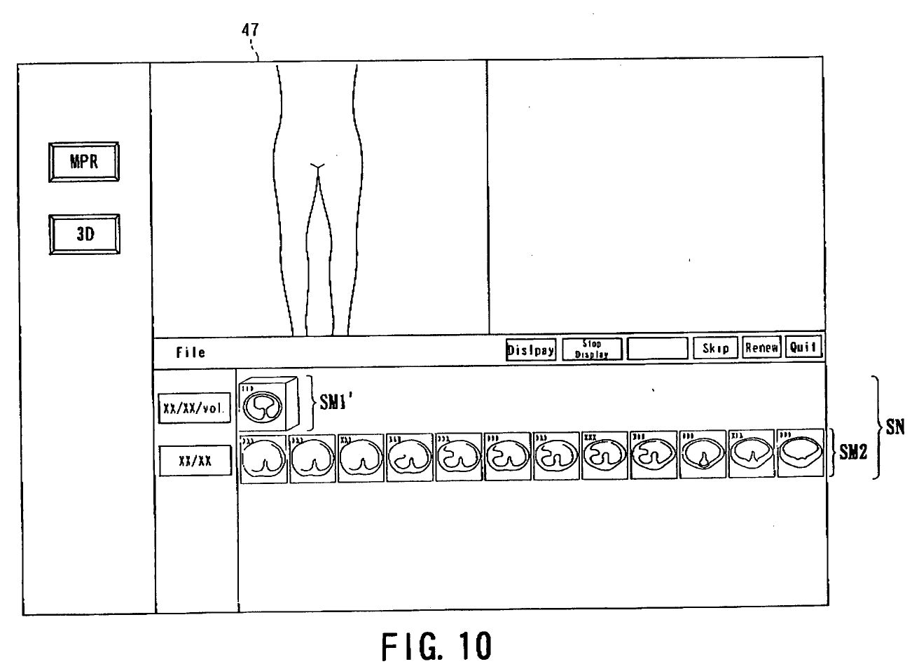

First, the mode of display method for volume data prepared for this embodiment will be explained. As such a display method, in this embodiment, when volume data has been acquired by a study of a patient, selected on the screen as described later, there are provided a “one-line list display method” (see FIG. 6 described later) for showing, by a list with one line, that the above-described volume data is present, and a “volume thumbnail display method” (see FIGS. 7 and 10 described later) for performing a display by at least one representative thumbnail.

Both of the “one-line list display method” and “volume thumbnail display method” are different from the conventional display method in which image data on a plurality of slices constituting volume data is list-displayed or thumbnail-displayed with each of the plurality of slices left just as it is. Specifically, in the conventional case, upon designating a study of which the volume data has been acquired, all lists or thumbnails of a plurality of slices constituting the volume data have been displayed on the screen. Supposing the number of the plurality of slices is 1000, 1000 pieces of lists or thumbnails have been simultaneously displayed on the screen.

In contrast, the “one-line list display method” and “volume thumbnail display method” adopted in this embodiment are each a display method for collectively showing, on the screen, that a plurality of slice image data constituting the volume data is present. Specifically, for the “one-line list display method”, as shown in FIG. 6, additional information for volume data (i.e., the comment information (the flag information) besides the series ID, image ID, presence/absence of contrast enhancement, kind of filter for reconstruction, etc.) is displayed as one-line character data.

On the other hand, for the “volume thumbnail display method”, as shown in FIG. 7, thumbnails of one or more representative slices representing a plurality of slices constituting volume data are displayed side by side. The number of these representative thumbnails is conditioned to be fewer than that of the plurality of slices. Preferably, slices located at the top, tail end, and the mid-point in the slice group, are automatically selected as representative slices, and the selected images are displayed. The representative slice may be the top slice alone, or the mod-point slice alone. Alternatively, the representative slices may be constituted of slices in which two or three of the slices located at the top, tail end, and the mid-point therein are combined as appropriate.

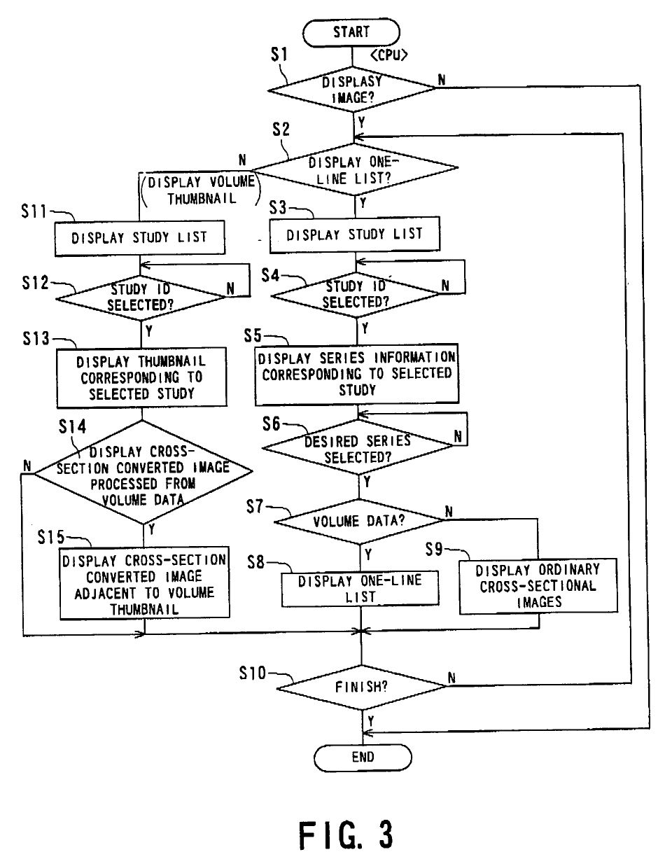

Next, with reference to a flowchart shown in FIG. 3, image display processing performed by the operator using the interface device 50 will be described.

As shown in FIG. 3, the CPU 41 interactively determines between the operator whether the images stored in the image database 45B after having been acquired by the multi-slice CT apparatus 1, are to be displayed (step S1). If it is determined that the image is to be displayed, the CPU 41 interactively determines between the operator whether the kind of a desired image display is the “one-line list display” provided as the display method for volume data according to the present invention (step S2).

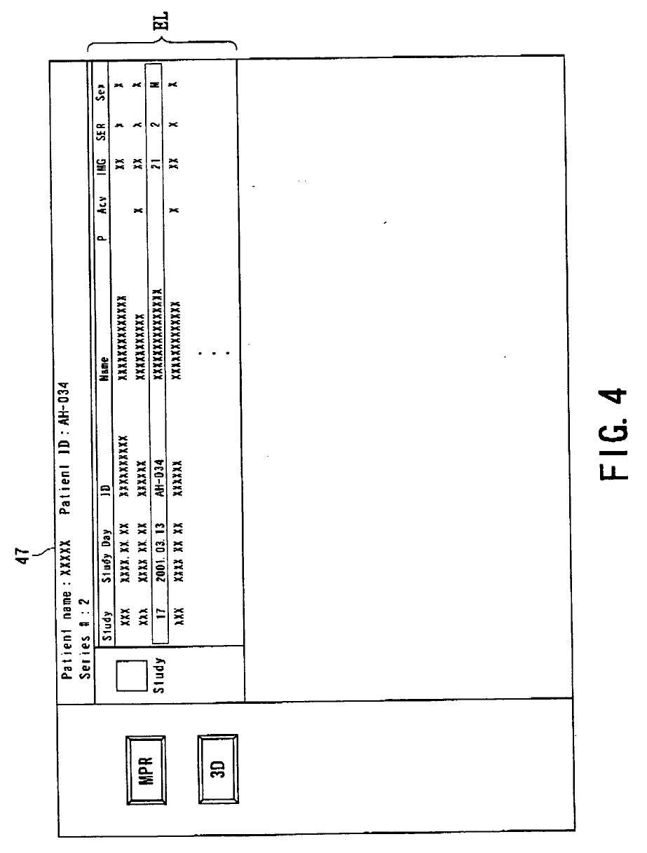

If this determination in step S2 is “YES”, that is, if the kind of the desired image display is “one-line list display”, the CPU 41 reads, from the image database 45B, additional information of each study stored in the image database 45B, and displays a study list as a list information about studies, on the monitor 47 (step S3; see FIG. 4). On this study list screen EL, the study ID, study day, patient ID, patient name, etc., which represent a study, are list-displayed by items.

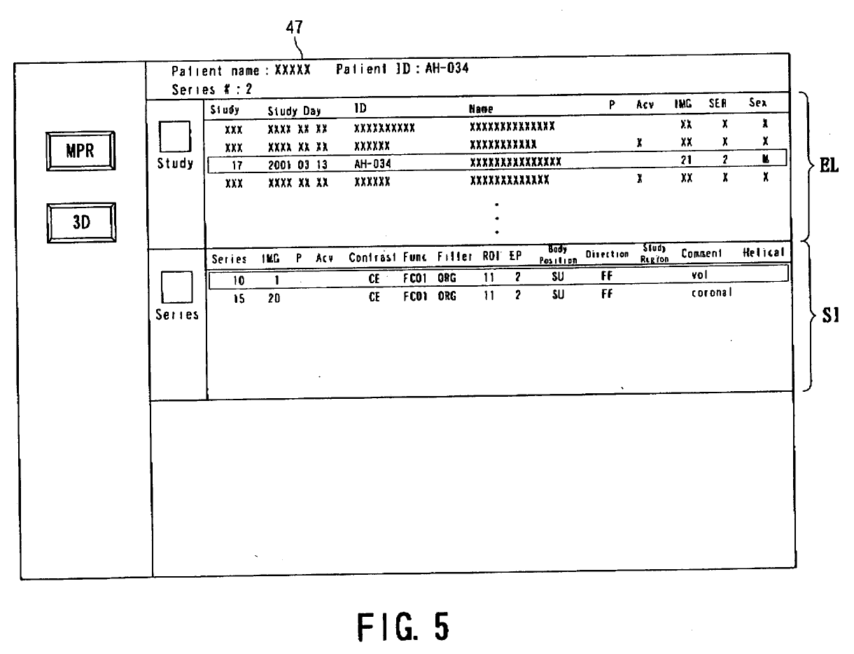

If, on this study list, a desired study (study ID) is selected by the operator (step S4), the CPU 41 reads, from the image database 45B, series information positioned at a lower hierarchical level than the selected study, and displays it to the monitor 47 (step 5; see FIG. 5). On this series information screen SI, besides the series ID, top image ID, presence/absence of contrast enhancement and so on, the comment on whether the pertinent image data is volume data or ordinary cross-sectional image data is list-displayed by items. If a pertinent image data is volume data, display of “vol.” is made on the “comment” section, and if the pertinent image data is ordinary cross-sectional image data, display of “coronal”, “axial”, “saggital”, or the like is made on the “comment” section. Regarding the display of “vol.” on the “comment” section, the CPU 41 may display it upon automatic determination based on the slice width and slice distance. Alternatively, the operator may manually fill in the “comment” section using a flag at the time of image data imaging. When the CPU is to automatically determine whether the pertinent image data is volume data, for example, if a slice distance is set to be not more than a slice width, the CPU may identify the pertinent image data as volume data. Another possible volume data determination method is such that identical volume data reconstructed from projection data by the reconstruction device 44 is labeled with an identification (ID), and based on this ID, it is determined whether the pertinent image data is the identical volume data.

Next, on the series information screen SI, the CPU 41 causes the operator to interactively select a desired series item (step S6). Furthermore, the CPU 41 determines whether the selected series item is a series of the volume data, based on a flag or the like (step S7). If this determination is “YES”, that is, if the selected series item is a series of volume data, the CPU 41 displays “one-line list” for collectively showing the presence of volume data on the designated series, the volume data having been prepared and stored in advance based on the image database 45B (one-line list display).

FIG. 6 shows an example of the one-line list screen OL. As shown in FIG. 6, the one-line list screen OL displays, in one line, items such as additional information for collectively showing volume data, that is, the image ID (image), number of image files (Frm), scan time, starting position/ending position, mode, contrast-enhancement, display FOV, slice width, function, filter, and so on. As a result, a series positioned subordinately to a designated study of patient, and further volume data as image data positioned subordinately to that series, can be collectively recognized in the form of one line.

If the determination in the above-described step 7 is “NO”, the CPU 41 displays designated ordinary cross-sectional images (coronal images, saggital images, axial images, oblique images, or the like) on the monitor 47 (step S9).

Upon completion of such a one-line display or ordinary display of image data, the CPU 41 interactively determines with the operator whether the display processing is to be finished (step S10). When the display processing is to be finished, the CPU 41 finishes processes shown in FIG. 3. On the other hand, when continuing the display processing, the CPU 41 transfers the processing to step S2 to repeat the above-described processes.

On the other hand, if the determination in step S2 is “NO”, that is, if the operator selects the ‘volume thumbnail display’, the CPU 41 causes the monitor 47 to display the study list screen EL as in the case of the above-described step S3 (step S11). Next, on this study list screen EL, the CPU 41 causes the operator to select a desired study (patient)[step S12], and reads image data on thumbnails corresponding to the selected study and prepared/stored in advance in the image database 453, to thereby displays on the monitor 47 (step S13). The thumbnails comprise study volume data positioned at a lower hierarchical level than the selected study, and/or thumbnails of ordinary tomogram data.

FIG. 7 exemplifies this thumbnail display screen SN. At least one of the volume data and ordinary tomogram data is present in a position at a lower hierarchical level than the selected study. Therefore, as shown in FIG. 7, when both of the volume data and ordinary tomogram data (non-volume data) are present, a thumbnail screen SM1 collectively showing the presence of volume data on the upper row is displayed together with an index “vol.”, and below that, a thumbnail screen SM2 showing ordinary tomogram data by the number of images is displayed. As representatives of a plurality of slices constituting the volume data, thumbnails of, e.g., three slices at the top, mid-point, and tail end are displayed on the thumbnail screen SM1 for showing the volume data.

This eliminates the need for the operator to watch thumbnails of all of the plurality of slices constituting the volume data. By watching thumbnails of some representative slice images, it is possible to easily recognize the presence of volume data, and proceed to subsequent required processes such as the MPR and a three-dimensional (3D) display.

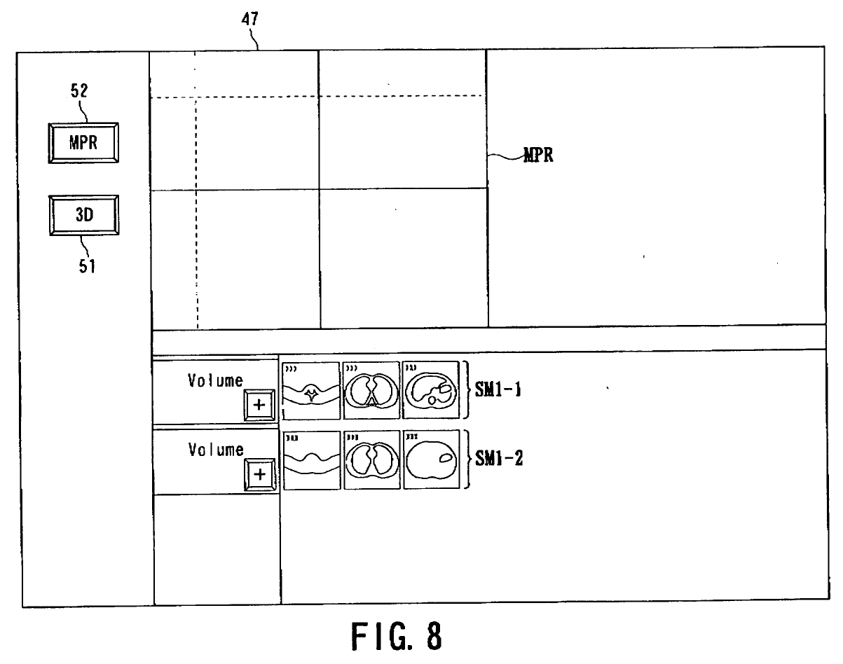

After that, by interactive communications with the operator, the CPU 41 determines whether the cross-section converted image data that has been subjected to secondary processing by the MPR from the volume data displayed in the above-described step S13 and that has been stored in the image database 45B, is to be displayed (step S14). This determination is executed, for example, by depressing an MPR button 52 on a screen shown in FIG. 8. Also, a three-dimensional display may be performed by depressing a 3D-button 51 shown in FIG. 8. Here, this determination includes the determination regarding the presence/absence of such cross-section converted image data that has been subject to the secondary processing.

Such being the case, if the determination in step 14 is “YES”, that is, if such cross-section converted image data is stored in advance together with its thumbnails in the image database 45B as data positioned at a lower hierarchical level than the volume data, and also the thumbnails of the cross-section converted image data is to be displayed, then the CPU 41 reads the above-described data and displays it on the monitor 47, e.g., in the row below the thumbnail display screen SM1 for showing volume data so as to be adjacent to this display screen SM1 (step S15). Alternatively, as shown in FIG. 8, MPR images themselves may be displayed in the upper part of the thumbnails.

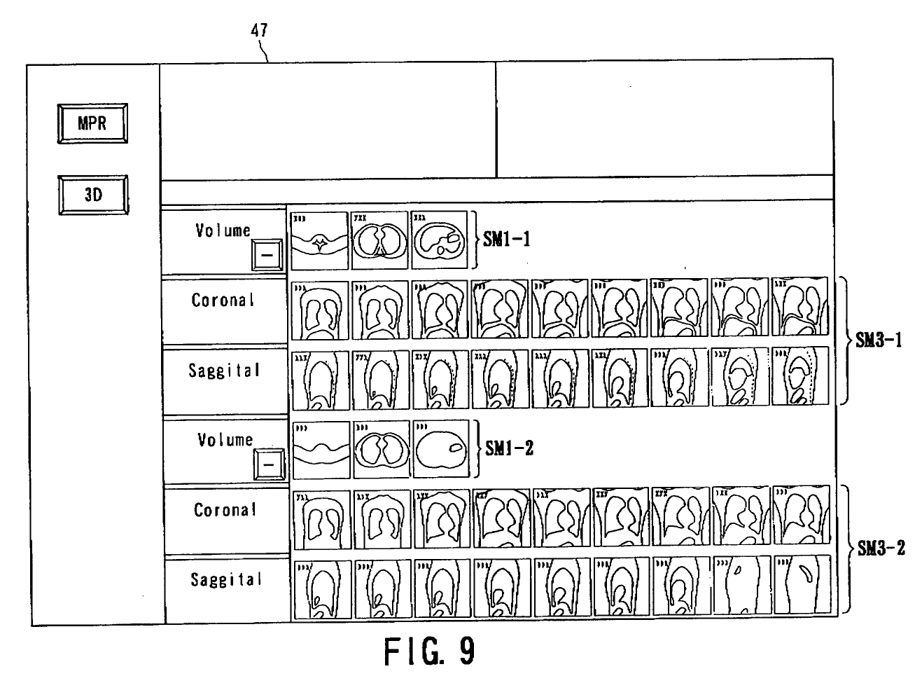

FIGS. 8 and 9 each show an example of thumbnail display screen SM3 for the above-described cross-section converted image data. FIG. 8 shows the thumbnail display screen SM1 for volume data, that is, thumbnails of the three representative slices. Here, each “+” button in this screen SM1 denotes a switch for giving trigger information concerning determination in the above-described step S14. In FIG. 9, in rows below each thumbnail display screen SM1 for volume data, a plurality of thumbnails of cross-section converted images, such as coronal images, saggital images obtained by subjecting the volume data shown in the upper row to secondary processing, are displayed over two lines (screens SM3). Each “−” button displayed on this screen denotes a switch for erasing thumbnails of cross-section converted images, although it is not shown in the processes in FIG. 3.

Thus, based on the displayed thumbnails of cross-section converted images, the operator can recognize information at a glance about what cross-section converted images have already been created from the volume data. That is, the operator can obtain such creation information in a simple and reliable manner virtually without the need to move line of sight on the screen of the monitor 47, thereby allowing improvement in operational efficiency. Furthermore, because the volume thumbnails and the thumbnails of cross-section converted images of the volume thumbnails are displayed so as to be mutually related, the operator can also recognize that the volume data has a characteristic like a folder positioned at an intermediate hierarchical level between the series information positioned at a lower hierarchical level than the study and each reconstructed cross-sectional image.

Here, the display position of the thumbnail display screen SM3 for cross-sectional image data is not necessarily limited to a row below that of the thumbnail display screen SM1 for volume data. The display positions of the display screen SM3 may include a row above that of the display screens SM1, and a lateral position in the same row as that of the display screens SM1. It is essential only that the display position be a position where the displayed thumbnails of cross-sectional images look integrated with the volume data that is the original data on the above-described displayed thumbnails of cross-sectional images.

If the CPU 41 made a determination of “NO” in step S14, and if it completed the display processing of cross-sectional images in step S15, the CPU 41 shifts the process to the above-described S10, and if the display processing is to be continued, the CPU 41 transfers the process to step S2 to repeat the above-described processes.

Out of the series of steps shown in FIG. 3, all steps do not necessarily require to be performed. Specifically, an arrangement may be used such that steps S1 to S10 alone are performed by the CPU 41 and that there is provided the interface device 50 that performs only the one-line list display. An alternative arrangement may be employed such that steps S1, S2, and S11 to S13 alone are performed by the CPU 41, and that there is provided the interface device 50 that performs only the thumbnail display. A further alternative arrangement may be used such that steps S1, S2, and S11 to S15 alone are performed by the CPU 41, and that there is provided the interface device 50 that performs only the thumbnail display and the display of cross-sectional images in display positions adjacent to each other A still alternative arrangement may be employed such that steps S14 and S15 alone are omitted from the series of steps shown in FIG. 3, and that there is provided the interface device 50 that can selectively perform the one-line list display and the thumbnail display through the processing of the remaining steps.

As described above, according to the console C in the multi-slice CT apparatus 1 of the present invention, volume data acquired in the study is displayed as information for collectively showing the presence of the pertinent volume data, e.g., as a one-line list or thumbnails of representative slices. Thus, instead of displaying information about all slices constituting the volume data, it is possible to show that the designated study is accompanied with the volume data, on the monitor screen in a simple and accurate manner by virtue of the above-described collective display of information, thereby allowing the facilitation of treatment of the volume data.

Thereby, it is possible to avoid the conventional inconvenience of all lists or all thumbnails of a plurality of slices being displayed and occupying the monitor screen when a study of which the volume data has been acquired is designated on the study list display screen. Simultaneously, by displaying a one-line list or thumbnails of representative slices for collective display, it is possible to provide, on the monitor, information that volume data has been acquired in the designated study. This facilitates the treatment of volume data display, as well as allows making effective use of information about subsequent display processes or image-reading.

Lastly, a modification example of volume thumbnails will be described. In the modification example, as shown in FIG. 10, a volume thumbnail SM1′ is displayed as a solid including one slice image out of a plurality of slice images constituting volume data. Specifically, the volume thumbnail SM1′ is displayed in the form such that the thumbnail of one representative slice representing a plurality of slices constituting the volume data is displayed on a side surface on this side of a perspective view of a rectangular parallelepiped symbolizing the volume data.

Displaying the volume thumbnail in this way allows us to more intuitively grasp that it represents volume data. Pieces of the cross-sectional image data SM3 such as “coronal”, “saggital”, and the like, are images to be selectably displayed on an individual basis. In contrast, the volume thumbnail SM1 is an original image for reconstructing these cross-sectional images, and is an image to be displayed as a set. This feature allows the volume thumbnail SM1 to be clearly distinguished from the above-described cross-sectional image data SM3.

Therefore, as in the case of the above-described embodiment, the slice image to be displayed on this side surface of the solid may be a top slice, intermediate slice, or tail end slice. Alternatively, the slice images to be displayed there may be a plurality of slices in which these slices are appropriately combined may be used. Further alternatively, arrangements may also be adopted such that the top slice is displayed on a first solid; the intermediate slice is displayed on a second solid; and the tail end slice is displayed on a third solid.

It is to be understood that the present invention is not necessarily limited to the above-described embodiment, but may be practiced by appropriately combining the above-described embodiment with known arts or by appropriately modifying it, within the spirit and scope as set out in the accompanying claims. For example, the medical modality that acquires image data is not necessarily restricted to an X-ray CT apparatus, but may also be a magnetic resonance imaging (MRI) apparatus. Furthermore, as described above, the medical image display apparatus according to the present invention is not necessarily required to be constructed integrally with a medical modality, but may be constructed as a dedicated apparatus comprising a terminal (computer device) connected to a medical image database by communication line or the like so as to be capable of data communications.

What is claimed is:

1. A medical image display apparatus comprising:
an image data storage device for storing image data for each study, acquired from a subject by a medical modality, and additional information thereof;
a list information display device for displaying list information about the study on a monitor based on the additional information;
a study selection device for selecting a study from the list information displayed on the monitor, in accordance with designated information; and
a volume data presentation device for presenting volume data corresponding to the selected study and included in the image data, as information for collectively showing the presence of the volume data.

2. The medical image display apparatus according to claim 1, wherein the volume data presentation device comprising:
a series display device for displaying, on the monitor, series information about the study designated in the list information together with information showing whether the volume data has been acquired in the study, as information by series;
a series data selection device for selecting series having the volume data from the information by series, displayed on the monitor, in accordance with designated information; and
a one-line list display device for collectively displaying the volume data that the series selected by the series data selection device has, as a list with one line.

3. The medical image display apparatus according to claim 2, wherein the list with one line, displayed by the one-line list display device comprises character information showing the presence of the volume data.

4. The medical image display apparatus according to claim 1, wherein the volume data presentation device comprising;
a thumbnail display device for displaying, by thumbnails, the image data corresponding to the study designated by the list information, together with at least one volume thumbnail that is a thumbnail of slice data representative of the volume data included in the image data.

5. The medical image display apparatus according to claim 4, wherein the at least one volume thumbnail displayed by the thumbnail display device is a thumbnail of at least one slice image out of a plurality of slice images constituting the volume data.

6. The medical image display apparatus according to claim 4, wherein the volume thumbnails displayed by the thumbnail display device are thumbnails of at least two slice images including the top and tail end slice images out of a plurality of slice images constituting the volume data.

7. The medical image display apparatus according to claim 4, wherein the at least one volume thumbnail displayed by the thumbnail display device is displayed as a solid including one slice image out of a plurality of slice images constituting the volume data.

8. The medical image display apparatus according to claim 4, further comprising:
a cross-section converted image storage device for previously storing cross-sectional images obtained by subjecting the volume data to cross-section conversion so that the cross-sectional images constitute a hierarchy together with the volume data;
a determination device for determining whether the cross-sectional images are to be displayed; and
a cross-sectional image display device for displaying the cross-sectional images using thumbnails by positionally relating the cross-sectional images to thumbnails of the volume data, when it is determined, by the determination device, that the cross-sectional images are to be displayed.

9. The medical image display apparatus according to claim 4, wherein the cross-sectional image display device is a device for displaying the thumbnails of the cross-sectional images in a line adjacent to a display line of the thumbnails of the volume data.

10. A method for displaying volume data using a medical image display apparatus comprising the steps of:
storing image data for each study, acquired from a subject by a medical modality, and additional information thereof;
displaying list information about the study on a monitor based on the additional information;
selecting a study from the list information displayed on the monitor, in accordance with designated information; and
presenting volume data corresponding to the selected study and included in the image data, as information for collectively showing the presence of the volume data.
